(19) United States
(12) Patent Application Publication
(10) Pub. No.: US 2025/0329312 A1
(43) Pub. Date: Oct. 23, 2025

(54) Guitar Pick that Allows the Player to Instantly Switch Between Pick-Playing and Fingerstyle

(71) Applicants: Syed Irfan Khalid, Summerville, SC (US); Lina Khalid, Summerville, SC (US)

(72) Inventors: Syed Irfan Khalid, Summerville, SC (US); Lina Khalid, Summerville, SC (US)

(21) Appl. No.: 19/176,810

(22) Filed: Apr. 11, 2025

Related U.S. Application Data
(60) Provisional application No. 63/636,697, filed on Apr. 19, 2024.

(51) Int. Cl. G10D 3/00

(52) U.S. Cl. CPC G10D 3/00

(57) ABSTRACT

The invention is a guitar pick allowing players to instantly switch between pick playing and fingerstyle. The pick has an open slot at its edge for insertion of a replaceable band, securing the pick to the thumb or forefinger. The pick pivots along edge of thumb/finger so the player can rotate it down for pick playing or up for fingerstyle. Alternative designs are also presented which don't require an open slot in the pick and use either a U-shaped band or adjustable strap. An option is also presented with the pick screwed into a U-shaped band, allowing it to pivot along the screw's shaft. The designs allow easy band replacement and adjustability. This invention includes any variations in pick & band shape, size, thickness, material, attachment methods, and pivot mechanisms that achieve the described functionality.

### CROSS-REFERENCE TO RELATED APPLICATIONS

Provisional Patent Application No. 63/636,697 filed Apr. 19, 2024

### BACKGROUND OF THE INVENTION

This invention relates to guitar picks, also called plectrums, which are widely used tools for playing the guitar. Picks are generally made of one uniform material such as some kind of plastic (nylon, Delrin, celluloid, Ultem). They are often shaped in an acute isosceles triangle with the two equal corners rounded and the third corner less rounded. They are used to strum chords or to sound individual notes on a guitar. Guitar picks are widely used by guitar players ranging from student musicians to professionals. Picks are common accessories sold in music stores, and they are supplied for the music industry and consumer market.

A traditional guitar pick is typically held between the thumb and forefinger of the strumming hand. When playing guitar, it is often desired to switch back and forth between pick playing and using only fingers plus thumb, to achieve different sounds. Switching to playing without a pick is ideal for techniques including fingerstyle or tapping. During performances, when making this switch with a traditional pick, the player must remove the pick from the thumb/forefinger to free up the thumb & forefinger for fingerstyle playing. This usually requires the player to quickly tuck the pick near the back of the strumming hand using rear fingers to hold the pick. This is not ideal since it makes some of the fingers on that hand unusable or less capable for playing. There is also a risk of dropping the pick during this movement. Alternatively, some players will place the pick on their knee while sitting, or between their lips to free up all fingers. This is also not ideal since it makes fast transitions between picking and fingerstyle impossible or prevents singing during fingerstyle playing. For these reasons, the traditional pick limits the versatility of the musician.

### SUMMARY OF THE INVENTION

This invention provides a novel guitar pick that allows the player to quickly and reliably switch back and forth between pick playing and fingerstyle. The guitar pick is secured to a digit of the hand, typically the thumb or forefinger, by an attached mechanism that enables fast repositioning between picking and fingerstyle playing positions, without needing to release the pick or store it elsewhere. The pick is uniquely designed with an attached or detachable/replaceable band which is a soft elastic or semi rigid material, that secures the pick to either the thumb or forefinger, so the pick can be pointed down towards the strings for pick playing or upwards, away from strings, for fingerstyle playing. The switch can be made with one simple motion by the player that involves flipping the pick up or down using one of the fingers. The invention includes four distinct implementation options, as illustrated in accompanying images and formal drawings. Novel features include:
Unique pivot mechanisms enabling quick transitions
Replaceable or detachable bands for customization
A variety of band types (elastic, semi rigid, closed loop, U-shape, adjustable strap)
Unique attachment mechanisms for easy band or pick replacement
User-adjustable fit
Simplicity for ease of operation and producibility

### BRIEF DESCRIPTION OF DRAWINGS

FIG. 1. Option A—Guitar pick with slotted cutout & detachable elastic or semi rigid looped band

FIG. 2. Option A—Exploded Views

FIG. 3. Option B1—Guitar pick secured with one screw to a U-shaped semi rigid band

FIG. 4. Option B1—Exploded Views

FIG. 5. Option B1—Additional Views

FIG. 6. Option B2—Guitar pick secured with two screws to a U-shaped semi rigid band

FIG. 7. Option B2—Exploded Views

FIG. 8. Option C—Guitar pick with a closed cutout and detachable U-shaped semi rigid band

FIG. 9. Option C—Exploded Views

FIG. 10. Option D—Guitar pick with a closed cutout and adjustable elastic or semi rigid strap

FIG. 11. Option D—Exploded Views

FIG. 12. Demonstrates up/down positioning for fingerstyle and pick playing

FIG. 13. Illustrates up/down positioning relative to guitar strings

FIG. 14. Illustrates user-adjustable positioning via pick cutout

FIG. 15. Illustrates pick secured to index finger as an alternative to thumb

### REFERENCE NUMBERS FOR DRAWINGS

110. Guitar pick with slotted cutout (Option A)
112. Detachable elastic or semi rigid band (Option A)
114. Guitar pick with 1-screw mount (Option B1)
116. U-shaped semi rigid band (Option B1)
118. Screw (Option B1 & B2)
120. Guitar pick with 2-screw mount (Option B2)
122. U-shaped semi rigid band (Option B2)
124. Guitar pick with closed cutout (Option C)
126. Detachable U-shaped semi rigid band (Option C)
128. Adjustable elastic or semi rigid strap (Option D)

### DETAILED DESCRIPTION OF THE INVENTION

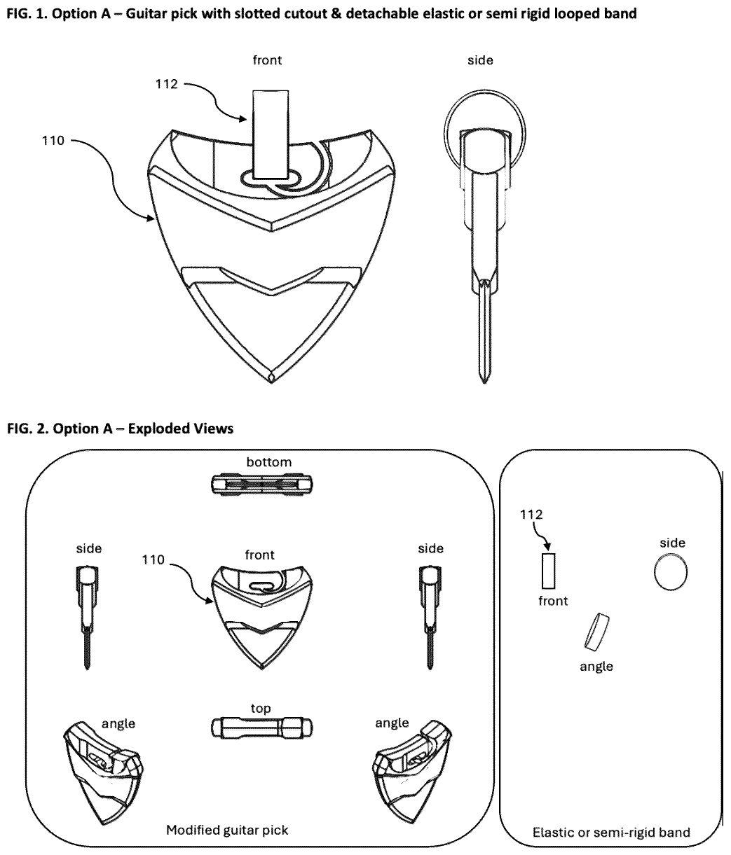

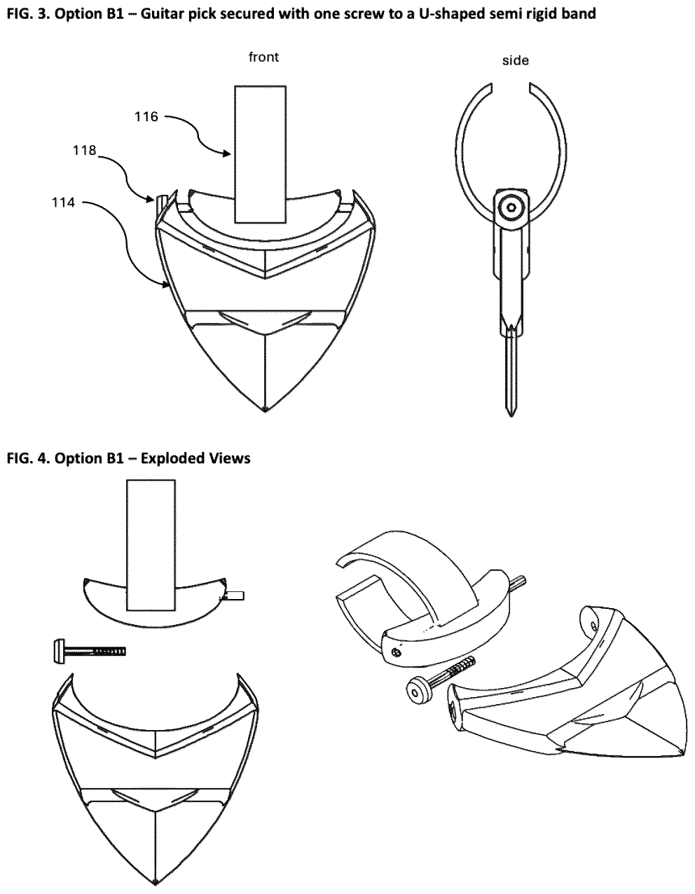

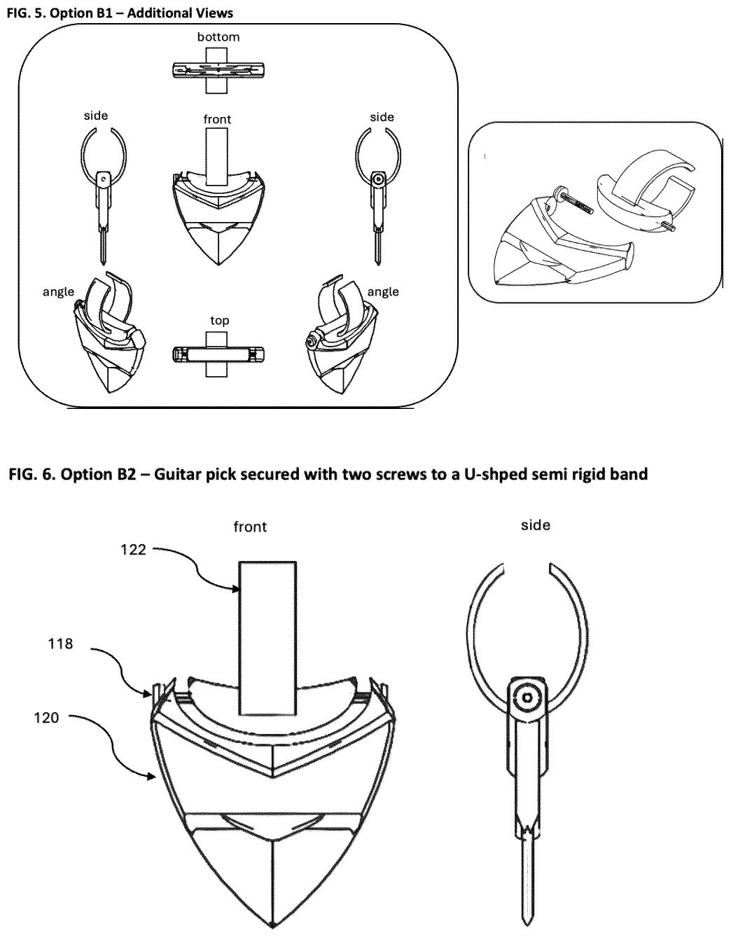

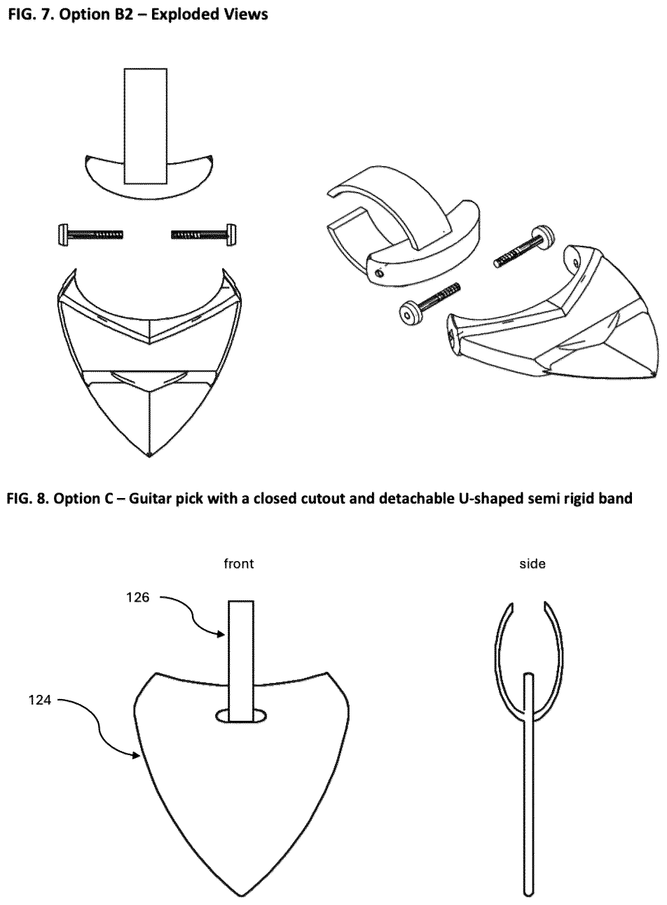

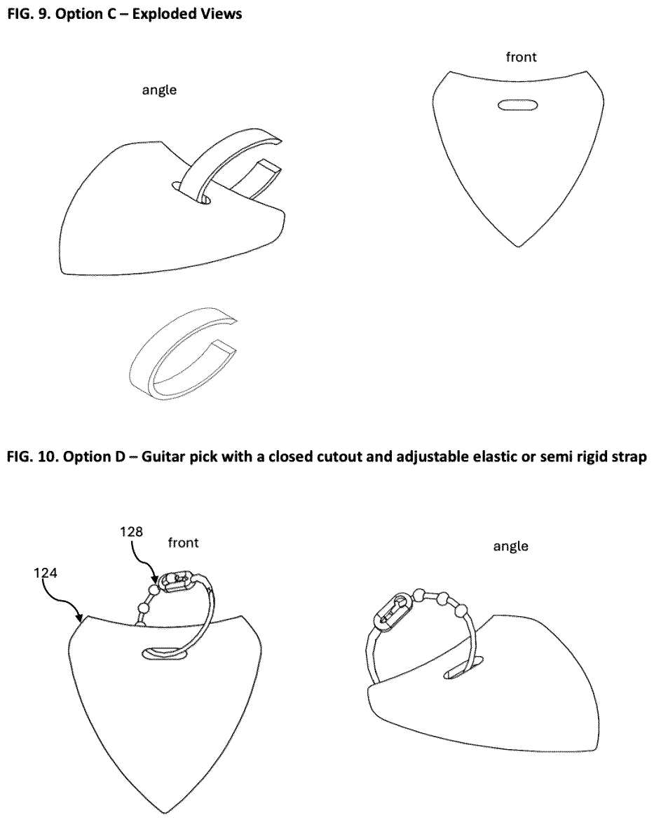

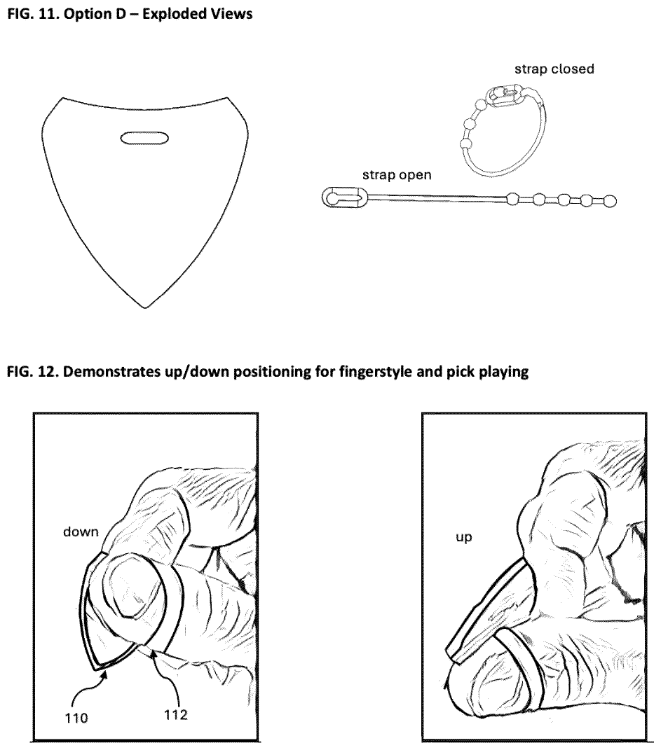

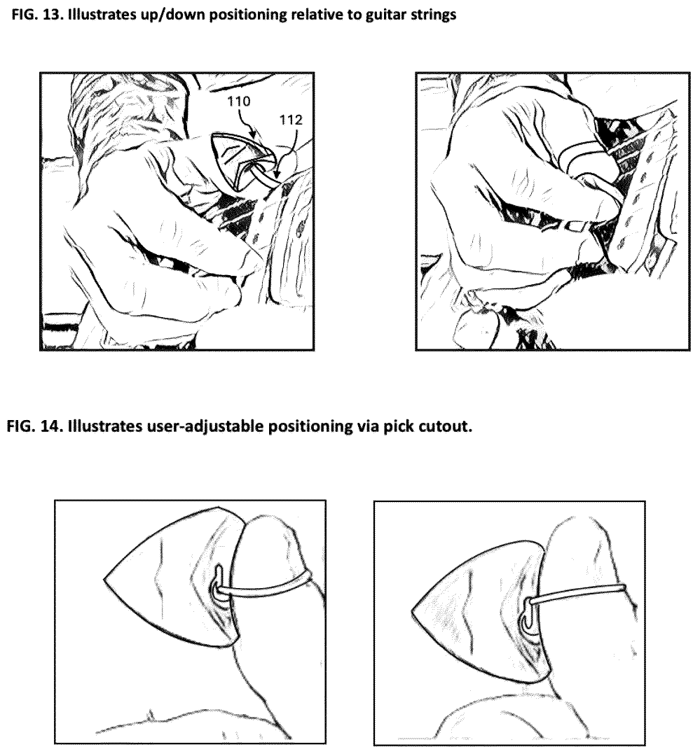

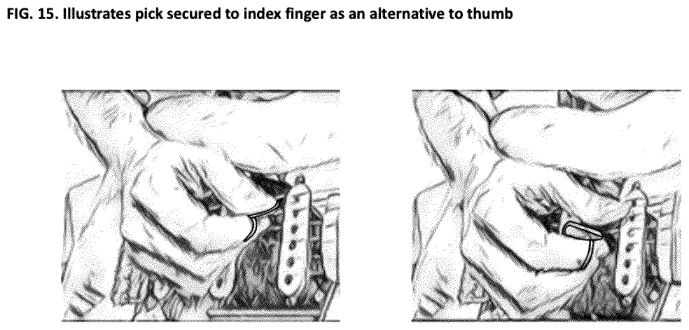

This patent is for the invention of a guitar pick with an elastic or semi rigid band that secures the pick to the thumb or forefinger, allowing the pick to pivot so the player can easily switch between pick playing (down position) or fingerstyle (up position). Four implementation options are presented encompassing different pivot mechanisms, band attachments, and types of bands, including a looped elastic or semi rigid band, a U-shaped semi rigid band, or an adjustable strap. All options enable the pick to fit a wide range of thumb and finger sizes.
Option A (FIG. 1): The guitar pick (110) features a slotted cutout at the top edge. The band (112) is a pre-formed closed loop that is inserted into the slot. The band is placed around the player's thumb or finger and is adjusted within the pick's cutout to the players preference. The band will stay secure during playing and is easily removed & replaced through the slot on the pick's edge allowing the player to choose proper size band. While a soft elastic band is desirable for comfort and responsiveness, the band can also be made of semi rigid material. The pick is automatically held in the up or down positions by the tension of the band against the finger or thumb.
Option B1 (FIG. 2): The pick (114) is secured into a U-shaped semi rigid band (116) with a single screw (118) or similar fastener. The screw has a smooth shaft section to allow pivoting, while the threaded section attaches it securely to the band. The opposite side of the band is pre-formed with a shaft that is inserted into a recessed cavity in the pick. The pick pivots smoothly along the screw's smooth shaft and the band's shaft. The band is flexible enough to fit snug on the thumb or finger for controlled pivoting. The pick is automatically held in the up or down positions by the screw, which is tight enough to secure the pick to the band while still allowing it to pivot up or down. Maximum tightening of the screw in the down position can eliminate any pivoting, to convert the pick into a fixed thumb-pick if desired. Additionally, the pick or band sections can be replaced by removing the screw.
Option B2 (FIG. 3): Similar to Option B1, but with two screws (118), one on each side of the pick (120), to secure it to the U-shaped band (122). The screws permit pivoting along both shafts. The band is flexible to achieve a comfortable and snug fit. Tightening both screws allows use as a non-pivoting thumb-pick if preferred.
Option C (FIG. 4): The pick (124) features a closed cutout rather than a slotted one. A detachable U-shaped semi rigid band (126) is inserted into this cutout and wraps around the finger or thumb. This closed cutout provides added structural integrity/stiffness, allowing the pick's upper section to be made thinner than in Option A. Like Option A, it allows quick pick repositioning and band replacement.
Option D (FIG. 5): This option features a closed cutout, and an adjustable strap (128) made of elastic or semi rigid material. The strap forms a loop via a closure mechanism (e.g., a bead-lock feature similar to a beaded cable tie, or a sliding track-based mechanism), allowing users to adjust the fit for size, comfort and stability. The pick pivots freely and remains secure in either position.

Additional unique features of the invention:
All Options: The assembly is designed with a slight arc on the top section which allows the pick to rest flush on thumb or forefinger, enabling a smooth and reliable pivot between pick up and pick down positions.
All Options: The bands are very strong to last for multiple performances and are easily replaceable using the detachment/attachment method.
Options A & D: The thin, soft, & flexible elastic bands allow for maximum pick sensitivity for the player by minimizing any resistance or stiffness when striking strings. This flexibility makes the pick feel natural and unconstrained, like using a traditional pick.
Options A & D: The elastic band is thin & low profile to prevent any mechanical interference with guitar strings or guitar pickups during playing.
Options A, C, & D: The bands are either transparent or colored and can be made from a wide range of materials that have smooth/low friction surface allowing fast and reliable pivot of the pick.
Option A: The pick is designed and manufactured with several sections of different thicknesses and shapes to ensure proper stiffness and tone. This design compensates for any stiffness reductions associated with the cutout, thereby preserving tone & volume. Tonal characteristics can also be customized far more than a traditional pick, by adjusting the thickness & shape of specific sections of the pick. This allows adjustment in level of bass, treble, and mid-range frequencies produced by the pick contacting the strings.

### Materials and Manufacturing Methods

The pick materials include but are not limited to:
Ultem (PEI)
Delrin (POM)
Acrylic
Polycarbonate
Celluloid
Nylon
Carbon Fiber

The picks can be manufactured in multiple thicknesses (i.e. less than 1 mm or more than 1 mm, or combination of different thicknesses) using typical methods for making plastic consumer parts including:
Plastic injection mold
Precision machining
Cutout from flat plastic sheets

The soft elastic band materials include but are not limited to:
TPU
Silicone
Nylon
Spandex/Microfiber
Nitrile
Fluorocarbon
Neoprene
Polyurethane
PTFE
Latex

The soft elastic bands can be manufactured with a thickness in the range of 1 mm or less, and with varying diameters and widths, using typical methods for making rubber bands, clothing elastics, O-rings, dental elastics, and hair bands. These include but are not limited to:
Compression Molding
Injection Molding
Extrusion plus splicing
Die-cutting
Braided & Weaving
Welding
Sewing

The semi rigid band materials include but are not limited to:
Ultem (PEI)
Delrin (POM)
Acrylic
Polycarbonate
Celluloid
Nylon
Carbon Fiber

The semi rigid bands (looped or U-shaped) can be manufactured with a thickness of 1 mm or less or can be made with combination of thickness (i.e. thinner at connection point with pick, and thicker for sections that secure to the finger or to screws), and with varying widths & diameters. These can be manufactured using typical methods for making plastic consumer parts including:
Plastic injection mold
Precision machining
Cutout from flat plastic sheets

This invention includes any variation in pick shape, size, thickness, cutout, slot, color, or material, combined with any type, shape, size, and material of flexible or semi rigid band that achieves the described function. The band can be a soft elastic or semi rigid loop, a U-shaped semi rigid band, or adjustable strap, with any thickness, width, or diameter that fits snug on thumb or finger. Additionally, a single band can be made with a combination of more than 1 thickness or width to achieve best fit, comfort, or overall performance.

While several specific implementations are described herein, the invention is not limited to the shapes, materials, attachment methods, or pivot mechanisms disclosed. Alternative embodiments may utilize magnetic, mechanical, adhesive, friction-fit, or other means for attachment and/or pivoting, so long as they enable the functionality described. Variations achieving substantially the same result using equivalent structures or methods are also considered within the scope of the invention.

What is claimed is:

1. A guitar pick assembly configured to enable a user to switch between pick playing and fingerstyle playing without removing the pick from the hand, comprising:
(a) a guitar pick having a playing edge and an attachment portion; and
(b) a band secured to the attachment portion, the band being configured to encircle a digit of the user's hand and support pivoting of the pick,
wherein the pick is pivotable relative to the band between:
(i) a first position in which the playing edge is directed toward the guitar strings for pick playing, and
(ii) a second position in which the playing edge is directed away from the guitar strings to allow fingerstyle playing.

2. The guitar pick assembly of claim 1, wherein the band is a closed loop made of an elastic or semi-rigid material and is detachably insertable into a slotted cutout in the guitar pick.

3. The guitar pick assembly of claim 1, wherein the band comprises a U-shaped semi-rigid band attached to the pick using one or more fasteners that define a pivot axis, wherein the attachment means may include other mechanisms, such as magnetic, mechanical, or other attachment systems, suitable for performing the described function.

4. The guitar pick assembly of claim 3, wherein the fasteners are screws with a partially threaded shaft configured to enable pivoting of the pick relative to the U-shaped band, or the fasteners may include alternative fastening means, such as magnetic fasteners, mechanical snaps, or other suitable attachment means.

5. The guitar pick assembly of claim 1, wherein the band is a semi-rigid U-shape and is detachably insertable into a closed cutout in the guitar pick that does not include a slot.

6. The guitar pick assembly of claim 1, wherein the band is an adjustable strap configured to form a closed loop of variable diameter.

7. The guitar pick assembly of claim 1, wherein the pick includes a cutout allowing the pick to be repositioned along a length of the digit or to adjust the angle or placement of the pick relative to the strings.

8. The guitar pick assembly of claim 1, wherein the pick is securable to either the thumb or the index finger of the user, enabling different playing techniques.

9. The guitar pick assembly of claim 1, wherein the pick is further configured to stay in place in the first or second position using tension provided by the band or fastener, while allowing the user to move the pick to either position using natural finger movement without detaching the device.

10. The guitar pick assembly of claim 3, wherein the pick is further configured to lock in place in the first position through tightening the fastener to a maximum level, thereby enabling use as a thumb pick, or alternative locking mechanisms, such as magnetic or mechanical locking, may be employed.

11. The guitar pick assembly of claim 1, wherein the pick comprises regions of varying thickness or stiffness selected to preserve tonal quality and volume despite the presence of the cutout.

12. The guitar pick assembly of claim 11, wherein the varying thickness is further configured to influence tonal balance by adjusting bass, midrange, or treble frequencies produced when the pick contacts the guitar strings.

13. The guitar pick assembly of claim 1, wherein the assembly includes a curved top arc that enables resting flush against the user's thumb or forefinger to facilitate pivoting.

14. The guitar pick assembly of claim 1, wherein the band is detachable and replaceable, and may be made of various materials, such as elastic, semi-rigid, or flexible materials, or alternative materials with pivot functionality.
